(19) United States
(12) Patent Application Publication
(10) Pub. No.: US 2005/0135321 A1
(43) Pub. Date: Jun. 23, 2005

(54) Spatial wireless local area network

(76) Inventor: Jacob Sharony, Dix Hills, NY (US)

Correspondence Address: WILLIAMS, MORGAN & AMERSON, P.C., 10333 RICHMOND, SUITE 1100, HOUSTON, TX, 77042, US

(21) Appl. No.: 10/738,167

(22) Filed: Dec. 17, 2003

(51) Int. Cl. H04B 7/216

(52) U.S. Cl. 370/342

(57) ABSTRACT

The present invention provides a wireless local area network and a method for the implementing same. The method includes receiving a plurality of signals from a first plurality of antennae substantially concurrently at a second plurality of antennae, the plurality of signals having a substantially common frequency. The method also includes determining at least one transmission channel between the first and second pluralities of antennae using the plurality of signals.

### CROSS REFERENCE TO RELATED APPLICATIONS

This application is related to U.S. patent application ______, filed on ______.

### BACKGROUND OF THE INVENTION

1. Field of the Invention

This invention relates generally to wireless networks, and, more particularly, to a spatial wireless local area network.

2. Description of the Related Art

A wireless Local Area Network (LAN) is a flexible data communications system that can either replace or extend a traditional, wired LAN to provide added functionality. A traditional, wired LAN sends data packets from one piece of equipment to another across cables or wires. For example, wired LANs may use a shared architecture in which multiple devices may communicate by exchanging data packets via each cable or wire, i.e. the devices share the cables or wires. Wired LANs may also use a switched architecture in which each device may communicate via a switch by transmitting data packets along a dedicated cable or wire coupled to the switch.

Instead of the wires used in wired LANs, a wireless LAN relies upon radio waves to transfer data between one or more fixed or mobile units and one or more access points. Data is superimposed onto a radio wave through a process called modulation, and the carrier radio wave then acts as the transmission medium. Wireless LANs are typically believed to be intrinsically shared media, at least in part because air cannot be switched like wires, and a variety of shared wireless network standards have become popular. Examples of shared wireless network standards are the 802.11× standards ratified by the Institute of Electrical and Electronics Engineering (IEEE), which include the 802.11, 802.11a, 802.11b (also known as Wi-Fi), and 802.11g standards. Wireless LANs are used in various vertical and horizontal applications (e.g., retail, manufacturing, logistics, healthcare, education, public space, etc.). Recently, there has been a surge in the deployment of 802.11-based wireless infrastructure networks to provide wireless internet access services, especially in public “hot spots” covering airports, hotels, coffee shops, and the like.

Many wireless LANs use a so-called single-in-single-out (SISO) cellular sharing architecture. In the SISO architecture, a coverage area is divided into a number of cells. Mobile units within each cell may transmit and receive signals to or from an access point associated with the cell. However, only one mobile unit at a time may transmit signals to the access point, and the access point may only transmit signals to one mobile unit at a time. Consequently, many mobile units may have to compete for bandwidth in the SISO cellular sharing architecture. Moreover, the SISO cellular sharing architecture is not scalable.

Multiple-in-single-out (MISO) wireless LAN architectures have been developed, at least in part to increase coverage areas. For example, an access point may direct many focused beams of radio waves, typically referred to as pencil beams, simultaneously towards the plurality of mobile units. Each pencil beam may transmit a signal having an increased bit-rate and/or range between the access point and a corresponding one of the mobile units. However, MISO wireless LAN architectures that direct many pencil beams towards the mobile units may require complex tracking algorithms to maintain contact between the mobile units and the access point. A MISO wireless LAN architecture also typically requires complex control mechanisms to resolve channel contention, which may limit the scalability of the MISO wireless LAN architecture.

Multiple-in-multiple-out (MIMO) shared wireless LAN architectures have also been proposed. For example, a spatial multiplexing mode may be used to increase the bit rate for data sent from an access point and a single mobile user. In the spatial multiplexing mode, sometimes referred to as a fat-pipe mode, a single high-speed data stream, e.g. a 200 Mbps stream, may be divided into several lower speed streams, e.g. four 50 Mbps streams, at the access point. The divided streams may then be transmitted to the mobile user, where they are combined into a single stream. However, the divided streams are only suitable for providing a high-speed connection between the access point and the single mobile user. For another example, a spatial diversity mode may be used to increase the accuracy of the data stream by transmitting each bit from multiple antennae at different times.

### SUMMARY OF THE INVENTION

In one aspect of the instant invention, a method used in a wireless local area network is provided. The method includes receiving a plurality of signals from a first plurality of antennae substantially concurrently at a second plurality of antennae, the plurality of signals having a substantially common frequency. The method also includes determining at least one transmission channel between the first and second pluralities of antennae using the plurality of signals.

In another aspect of the present invention, an access point in a wireless local area network is provided. The access point includes a first plurality of antennae capable of receiving, substantially concurrently at a substantially common frequency, a plurality of signals from at least one mobile unit, each of the at least one mobile unit being associated with a second plurality of antennae. The access point also includes a processor communicatively coupled to the first plurality of antennae and capable of determining at least one transmission channel corresponding to the at least one mobile unit using the plurality of signals.

In yet another aspect of the present invention, a mobile unit for use in a wireless local area network is provided. The mobile unit includes a first plurality of antennae capable of receiving, substantially concurrently at a substantially common frequency, a plurality of signals from a second plurality of antennae associated with an access point. The mobile unit also includes a processor communicatively coupled to the first plurality of antennae and capable of determining a transmission channel corresponding to the mobile unit using the plurality of signals.

In a further aspect of the present invention, a wireless local area network is provided. The wireless local area network includes at least one access point having a first plurality of antennae capable of receiving and transmitting a plurality of signals substantially concurrently at a substantially common frequency. The wireless local area network also includes a plurality of mobile units, each mobile unit having a second plurality of antennae capable of receiving and transmitting a plurality of signals substantially concurrently at the substantially common frequency. The access point also includes a processor communicatively coupled to the first plurality of antennae and capable of determining a plurality of transmission channels using a plurality of signals transmitted by the second plurality of antennae associated with each of the mobile units and associating at least one of the plurality of transmission channels with a corresponding one of the mobile units. The mobile units also include a processor communicatively coupled to the plurality of antennae and capable of determining at least one transmission channel corresponding to the mobile unit using a plurality of signals transmitted by the first plurality of antennae associated with the access point.

### BRIEF DESCRIPTION OF THE DRAWINGS

The invention may be understood by reference to the following description taken in conjunction with the accompanying drawings, in which like reference numerals identify like elements, and in which:

FIG. 1 shows one exemplary embodiment of a wireless local area network including at least one access point and a plurality of mobile units;

FIG. 2A illustrates one embodiment of an access point, such as the access point shown in FIG. 1;

FIG. 2B illustrates one embodiment of a mobile unit, such as the mobile unit shown in FIG. 1;

FIG. 3A conceptually illustrates an exemplary embodiment of an downstream transmission that may be performed by the wireless local area network shown in FIG. 1;

FIG. 3B conceptually illustrates an exemplary embodiment of a upstream transmission that may be performed by the wireless local area network shown in FIG. 1; and

FIG. 4 shows an exemplary cellular wireless local area network.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

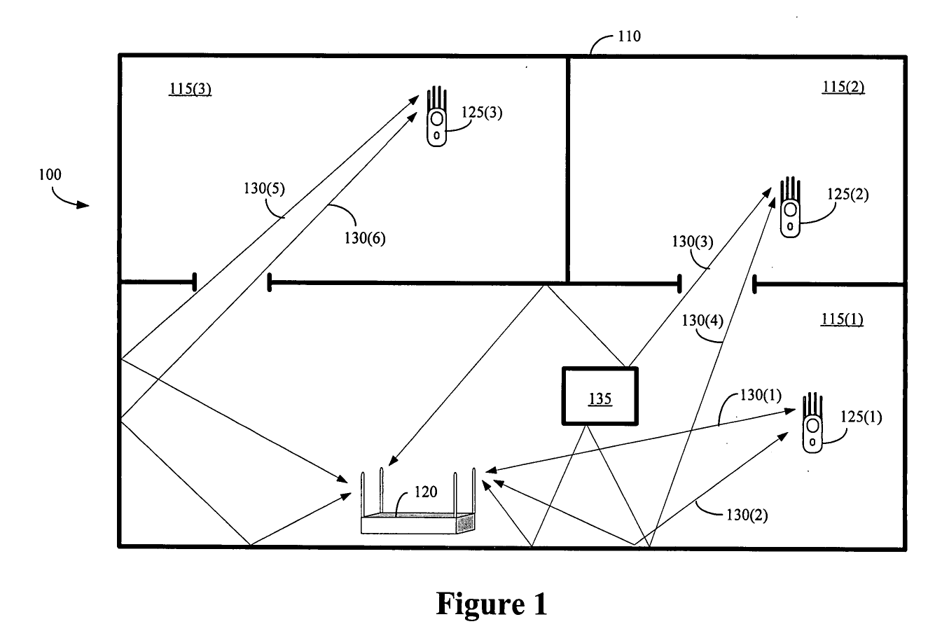

FIG. 1 shows one exemplary embodiment of a wireless local area network 100. In the illustrated embodiment, the wireless local area network 100 is deployed within an interior space 110, which includes a plurality of rooms 115(1-3). However, it will be appreciated by those of ordinary skill in the art that the present invention is not limited to wireless local area networks 100 that are deployed within interiors such as the interior space 110. In various alternative embodiments, some or all of the wireless local area network 100 may be deployed at any desirable location inside or outside of the interior space 110, as well as in any desirable number of rooms within the interior space 110.

The wireless local area network 100 shown in FIG. 1 includes an access point 120 and mobile units 125(1-3). In various alternative embodiment, the mobile units 125(1-3) may be cellular telephones, personal data assistants, bar code scanners, portable computers, desktop computers, and the like. Although three mobile units 125(1-3) are shown in the exemplary embodiment of the wireless local area network 100, persons of ordinary skill in the art will appreciate that the present invention is not limited to three mobile units 125(1-3) and that, in alternative embodiments, more or fewer mobile units 125(1-3) may be used.

Voice and/or data signals may be transmitted between the access point 120 and the mobile units 125(1-3). In one embodiment, the voice and/or data signals may be transmitted between the access point 120 and the mobile units 125(1-3) using a modulated radio signal having a common frequency, such as a 2.4 GHz modulated carrier radio signal. Alternatively, a 5 GHz modulated carrier radio signal may be used. The voice and/or data signals typically travel between the access point 120 and the mobile units 125(1-3) along a plurality of paths 130(1-6). In the interest of clarity, only six paths 130(1-6) are shown in FIG. 1. However, persons of ordinary skill in the art will appreciate that the number of possible paths between the access point 120 and the mobile units 125(1-3) is essentially infinite.

The distribution of potential paths between the access point 120 and the mobile units 125(1-3) depends upon the location of the access point 120 and the mobile units 125(1-3), the configuration of the interior space 110 and the rooms 115(1-3), as well as the location and/or shape of any other obstructions, such as the obstruction 135 shown in FIG. 1. For example, the path 130(1) may pass substantially directly from the mobile unit 125(1) to the access point 120, whereas the path 130(2) may reflect from a wall of the room 115(1). For another example, the paths 130(3-4) between the mobile unit 125(2) and the access point 120 may pass from the room 115(2) to the room 115(1) via a doorway 140(1), and may then reflect from one or more walls of the room 115(1). For yet another example, the paths 130(5-6) between the mobile unit 125(3) and the access point 120 may pass from the room 115(3) to the room 115(1) via a doorway 140(2), and may then reflect from the obstruction 135 and one or more walls of the room 115(1). Although not shown in FIG. 1, additional paths may pass through the walls and/or obstructions 135.

The voice and/or data signals transmitted by the access point 120 and/or the mobile units 125(1-3) may differ from the corresponding voice and/or data signals received by the access point 120 and/or the mobile units 125(1-3). For example, variations in the lengths of the paths 130(1-6) may result in variations in the signal amplitude, phase, arrival time, frequency distribution, intensity, and other like attributes of signals transmitted between the access point 120 and the mobile units 125(1-3). For another example, variations in the number of reflections along the paths 130(1-6), as well as variations in the reflectance of the reflecting surfaces, may also result in variations in the amplitude, phase, frequency distribution, intensity, and other like attributes of signals transmitted between the access point 120 and the mobile units 125(1-3). The aforementioned changes in the voice and/or data signals as they travel along the plurality of paths 130(1-6) between the access point 120 and the mobile units 125(1-3) are generally referred to by persons of ordinary skill in the art as multi-path fading of the voice and/or data signals.

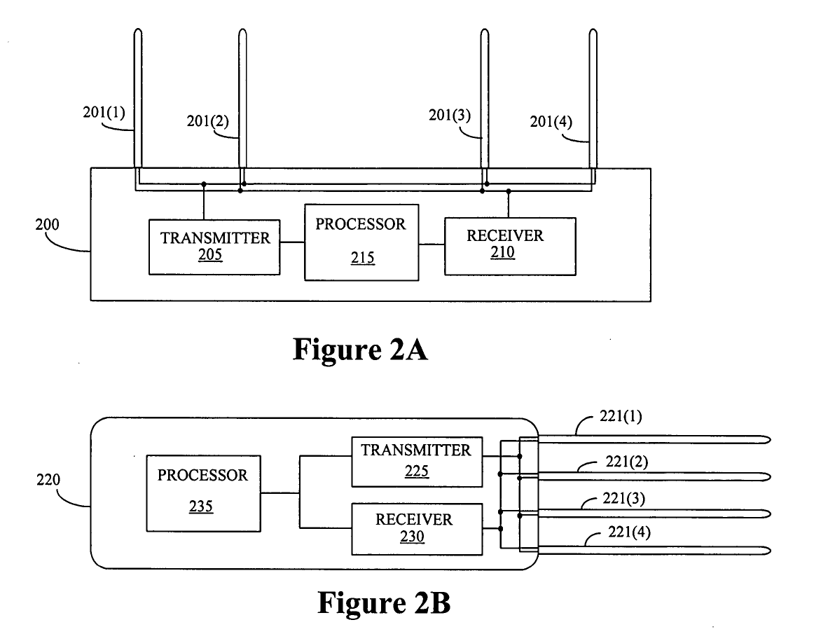

FIG. 2A illustrates one embodiment of an access point 200, such as the access point 120 shown in FIG. 1. The access point 200 includes a plurality of antennae 201(1-4) that may be coupled to a transmitter 205 and a receiver 210. The antennae 201(1-4) are each capable of transmitting an independent signal provided by the transmitter 205 and of receiving an independent signal that may be provided to the receiver 210. The antennae 201(1-4) are also capable of transmitting or receiving the independent signals concurrently at a substantially common frequency. For example, the antennae 201(1-4) may be capable of concurrently receiving or transmitting up to four independent modulated 2.4 GHz radio signals. However, the present invention is not limited to receiving or transmitting modulated radio signals at any particular frequency. For example, in one alternative embodiment, four independent modulated 5 GHz radio signals may be used. Although the embodiment of the access point 200 illustrated in FIG. 2A includes four antennae 201(1-4) capable of concurrently receiving or transmitting up to four independent signals, the present invention is not so limited. In various alternative embodiments, any desirable plurality of antennae 201(1-4), each capable of concurrently receiving or transmitting an independent signal, may be included in the access point 200.

In the illustrated embodiment, an access point processor 215 is communicatively coupled to the transmitter 205 and the receiver 210. For example, the access point processor 215 may be physically coupled to the transmitter 205 and the receiver 210 by wires, conductive traces, and the like so that signals may be transmitted between the access point processor 215 and the transmitter 205 and the receiver 210. As will be described in detail below, the receiver 210 may provide a signal indicative of the plurality of independent signals that may be received concurrently by the antennae 200(1-4) to the access point processor 215, which is capable of determining at least one transmission channel using the plurality of signals. For example, the access point processor 215 may determine a plurality of transmission channels that may be used to establish one or more communication links with a corresponding plurality of mobile units 125(1-3).

FIG. 2B illustrates one embodiment of a mobile unit 220, such as the mobile units 125(1-3) shown in FIG. 1. The mobile unit 220 includes a plurality of antennae 221(1-4) that may be coupled to a transmitter 225 and a receiver 230. The antennae 221(1-4) are each capable of transmitting an independent signal provided by the transmitter 225, such as a modulated 2.4 GHz radio signal, as described above. However, the present invention is not limited to transmitting modulated radio signals at any particular frequency. For example, in one alternative embodiment, a modulated 5 GHz radio signals may be used. In one embodiment, a single antenna 221(1) is used to transmit the independent signal provided by the transmitter 225. However, in alternative embodiments, any desirable number of the antennae 221(1-4) may be used to transmit the independent signal provided by the transmitter 225. For example, the transmitter 225 may provide phase-shifted versions of the independent signal to the antennae 221(1-4).

The antennae 221(1-4) are each capable of concurrently receiving an independent signal that may be provided to the receiver 230. For example, the antennae 221(1-4) may be capable of concurrently receiving up to four independent modulated 2.4 GHz radio signals. However, the present invention is not limited to receiving modulated radio signals at any particular frequency. For example, in one alternative embodiment, up to four independent modulated 5 GHz radio signals may be used. Although the embodiment of the mobile unit 220 illustrated in FIG. 2A includes four antenna 221(1-4), the present invention is not so limited. In various alternative embodiments, any desirable number of antenna 221(1-4), each capable of concurrently receiving or transmitting an independent signal at a common frequency, may be included in the mobile unit 220. For example, a single antenna 221(1-4) may be included in the mobile unit 220.

In the illustrated embodiment, a mobile unit processor 235 is communicatively coupled to the transmitter 225 and the receiver 230. For example, the mobile unit processor 235 may be physically coupled to the transmitter 225 and the receiver 230 by wires, conductive traces, and the like so that signals may be transmitted between the mobile unit processor 235 and the transmitter 225 and the receiver 230. As will be described in detail below, the receiver 230 may provide a signal indicative of the plurality of independent signals that may be received concurrently by the antennae 221(1-4) to the mobile unit processor 235, which is capable of determining at least one transmission channel, e.g., between the mobile unit and the transmitting access point, using the plurality of signals. For example, the mobile unit processor 235 may determine a transmission channel between the mobile unit 125(1) and the access point 120, shown in FIG. 1.

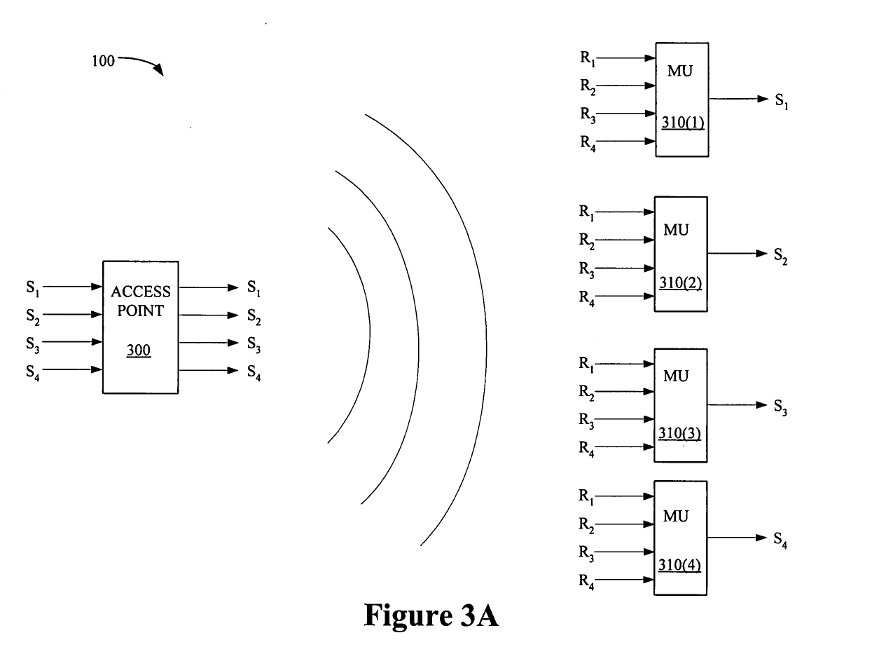

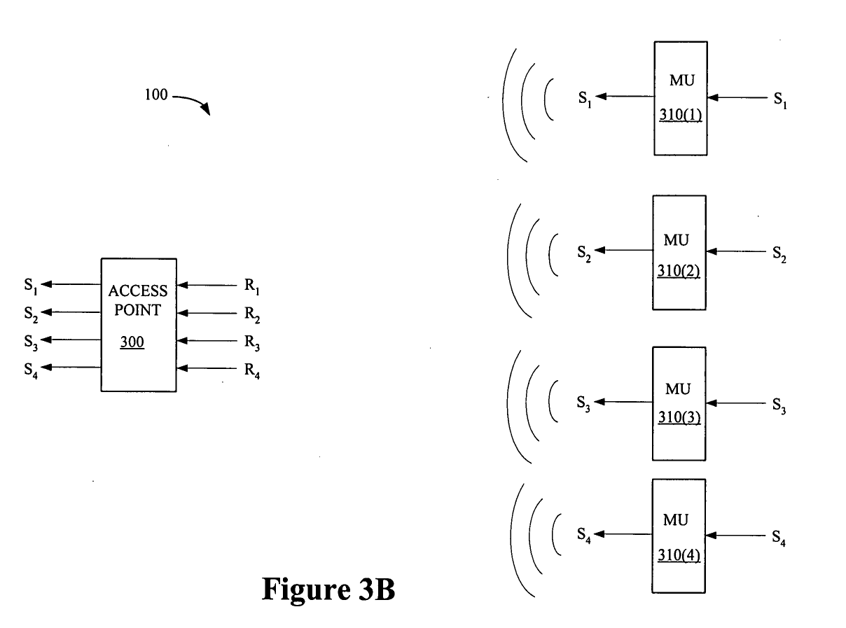

FIG. 3A conceptually illustrates an exemplary embodiment of a downstream transmission using the wireless local area network 100. In the illustrated exemplary embodiment, the wireless local network 100 includes an access point 300 and mobile units (MU) 310 (1-4). Symbols S₁, S₂, S₃, and S₄ may be transmitted by the access point 300. For example, the access point 300 may transmit symbols S₁, S₂, S₃, and S₄ concurrently at a common frequency using four or more antennae, such as the antennae 201(1-4) shown in FIG. 2. Due to the aforementioned multi-path fading, the mobile units 310(1-4) may concurrently receive the signals R₁, R₂, R₃, and R₄, which are related to the transmitted symbols S₁, S₂, S₃, and S₄ by the matrix equation

$${R}_{i} = {\sum }_{j}^{} {a}_{ij} {S}_{j} + {n}_{i} ,$$

where a_{i,j} are elements of a transmission matrix, and nᵢ represents the noise on a received channel i, e.g. a channel of the receiver and/or an antenna.

The mobile units 310(1-4) estimate the transmission matrix a using at least a portion of the received signals R₁, R₂, R₃, and R₄. In one embodiment, each of the transmitted symbols, Sⱼ, includes a predetermined training sequence, Tⱼ, indicative of the transmission channel j. The training sequence, Tⱼ, may include a predetermined pilot sequence, pⱼ that is transmitted as a portion of a preamble signal. For example, the access point 300 may send each of a plurality of pilot sequences p₁, p₂, p₃, p₄, in one of a sequence of successive predetermined time slots.

The mobile units 310(1-4) may identify the pilot sequences p₁, p₂, p₃, p₄ transmitted by the access point 300 in the predetermined time slots and estimate at least a portion of the transmission matrix using the equation: aᵢⱼ=Rᵢ/pⱼ. The mobile units 310(1-4) may then determine the appropriate transmission channel using the estimated transmission matrix a_{i,j} and thereby extract the appropriate symbol, Sⱼ. For example, the mobile unit 310(1) may use the estimated transmission matrix a_{i,j} to extract the symbol S₁ from the concurrently received signals R₁, R₂, R₃, and R₄.

FIG. 3B conceptually illustrates an exemplary embodiment of an upstream transmission using the wireless local area network 100. In the illustrated exemplary embodiment, symbols S₁, S₂, S₃, and S₄ may be transmitted by the mobile units (MU) 310(1-4), respectively. Due to the aforementioned multi-path fading, the antennae 201(1-4) on the access point 300 may concurrently receive the signals R₁, R₂, R₃, and R₄, which are related to the transmitted symbols S₁, S₂, S₃, and S₄ by the matrix equation

$${R}_{i} = {\sum }_{j}^{} {a}_{ij} {S}_{j} + {n}_{i} ,$$

where a_{i,j} are elements of a transmission matrix, and nᵢ represents the noise on a received channel i, e.g. a channel of the receiver and/or an antenna.

The access point 300 estimates the transmission matrix a_{i,j} using at least a portion of the received signals R₁, R₂, R₃, and R₄, which in this illustrative embodiment are received by at least the four antennae 201(1-4). In one embodiment, each of the received symbols, Rⱼ, includes a predetermined training sequence, Tⱼ, indicative of the transmission channel j, which is transmitted by a respective one of the mobile units 310(1-4). The training sequence, Tⱼ, may include a predetermined pilot sequence, pⱼ that is transmitted as a portion of a preamble signal. For example, the mobile units 310(1-4) may each send a corresponding pilot sequence p₁, p₂, p₃, p₄, in one of a sequence of successive predetermined time slots.

The access point 300 may identify the pilot sequences p₁, p₂, p₃, p₄ transmitted by the mobile units 310(1-4) in the predetermined time slots and estimate the transmission matrix using the equation: aᵢⱼ=Rᵢ/pⱼ. In one embodiment, the transmission channels corresponding to each of the mobile units 310(1-4) are then estimated using the estimated transmission matrix a_{i,j}, which may be used by the access point 300 to extract the symbols S₁, S₂, S₃, and S₄. For example, access point 300 may use the estimated transmission matrix a_{i,j} to extract the symbols S₁, S₂, S₃, and S₄ from the concurrently received signals R₁, R₂, R₃, and R₄.

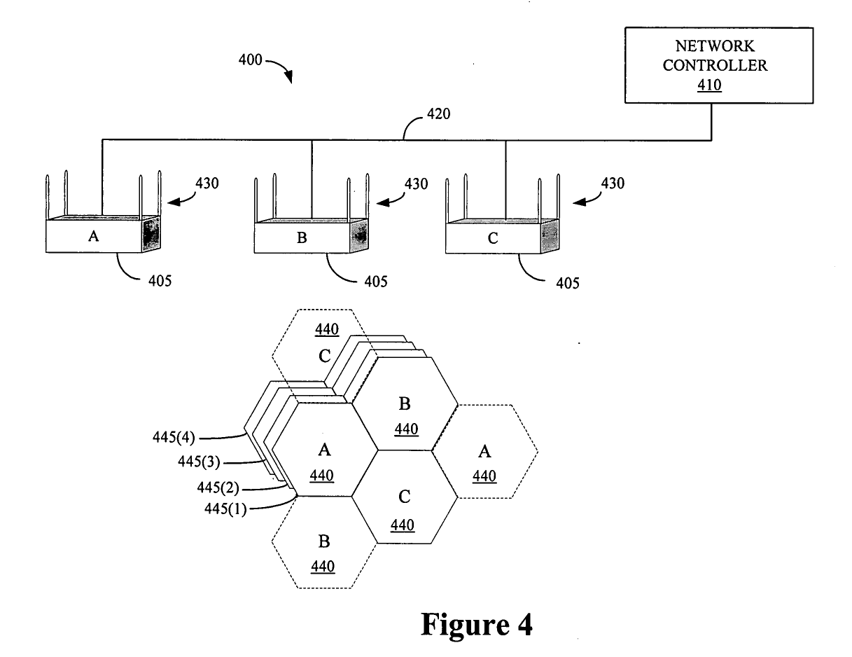

FIG. 4 shows an exemplary cellular wireless local area network 400 including a plurality of access points 405 (also labeled with letters A, B, C) coupled to a network controller 410 by a bus 420. The type of network controller 410 and bus 420 is not material to the present invention and, in various alternative embodiments, any desirable type of network controller 410 and bus 420 may be used. In the illustrated embodiment, each of the access points 405 includes four antennae 430. However, it will be appreciated by those of ordinary skill in the art that the present invention is not limited to access points 405 that include four antennae 430. In alternative embodiments, the access points 405 may include any desirable plurality of antenna 430.

The access points 405 may be used to establish a plurality of transmission channels to mobile units (not shown) within a plurality of cells 440. In the illustrated embodiment, the access point 405 indicated by the letter A may be used to establish a plurality of transmission channels to mobile units within the cells 440 indicated by the letter A, the access point 405 indicated by the letter B may be used to establish a plurality of transmission channels to mobile units within the cells 440 indicated by the letter B, and the access point 405 indicated by the letter C may be used to establish a plurality of transmission channels to mobile units within the cells 440 indicated by the letter C.

As described in detail above, each of the access points 405 is capable of concurrently transmitting or receiving voice and/or data signals on a plurality of transmission channels at a common frequency, such as a 2.4 GHz carrier frequency. However, the present invention is not limited to receiving modulated radio signals at any particular frequency. For example, in one alternative embodiment, a 5 GHz carrier frequency may be used. Each cell 440 may include a plurality of layers 445(1-4) corresponding to the plurality of transmission channels. Although four layers 445(1-4) are shown in FIG. 4, the present invention is not so limited. In alternative embodiments, any desirable number of layers 445(1-4) corresponding to a desired number of transmission channels, up to a number equal to the number of antenna 430 coupled to each access point 405, may be provided.

By providing the plurality of transmission channels, indicated in FIG. 4 by the plurality of layers 445(1-4), the cellular wireless local area network 400 may concurrently communicate with a plurality of mobile units (not shown) in each cell 440 using a carrier wave having a substantially common frequency. Consequently, the capacity of the cellular wireless local area network 400 may be increased. For example, in the illustrated embodiment, the capacity of the cellular wireless local area network 400 may be increased by as much as a factor of four.

Moreover, more than one of the transmission channels provided by the cellular wireless local area network 400 may be utilized by a single mobile unit. Thus, mobile units may utilize the cellular wireless local area network 400 in a variety of alternative modes, including a spatial multiplexing mode, a fat-pipe mode, a progressive bit rate mode, a spatial diversity mode, a space-time coding mode, and the like. In one embodiment of the progressive bit rate mode, a mobile unit may use a plurality of transmission channels to increase the overall bit rate that may be transmitted between the mobile unit and the access point 405. For example, a mobile unit in a four-channel system may utilize two of the four 50 Mbps transmission channels to achieve an overall bit rate of approximately 100 Mbps. Alternatively, in one embodiment of the spatial diversity mode, a mobile unit may use a plurality of transmission channels to increase the accuracy of transmissions between the mobile unit and the access point 405. For example, the mobile unit may transmit the same data independently along two transmission channels so that the number of transmission errors may be reduced by, e.g., comparing the data received independently along the two transmission channels.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
receiving a plurality of signals from a first plurality of antennae substantially concurrently at a second plurality of antennae, the plurality of signals having a substantially common frequency; and
determining at least one transmission channel between the first and second pluralities of antennae using the plurality of signals.

2. The method of claim 1, wherein receiving the plurality of signals comprises receiving a plurality of signals that traveled along different paths from the first plurality of antennae to the second plurality of antennae.

3. The method of claim 2, wherein determining the transmission channel comprises determining the transmission channel using the plurality of signals that traveled along different paths from the first plurality of antennae to the second plurality of antennae.

4. The method of claim 3, wherein determining the transmission channel comprises determining the transmission channel using a plurality of training sequences associated with each of the plurality of signals that traveled along different paths from the first plurality of antennae to the second plurality of antennae.

5. The method of claim 4, wherein determining the transmission channel comprises determining a transmission matrix using the plurality of signals that traveled along different paths from the first plurality of antennae to the second plurality of antennae.

6. The method of claim 5, wherein determining the transmission matrix comprises determining the transmission matrix using the plurality of training sequences.

7. The method of claim 6, wherein determining the transmission matrix using the training sequence comprises determining the transmission matrix resulting from the multiple paths between the first plurality of antennae and the second plurality of antennae.

8. The method of claim 4, wherein receiving the plurality of signals comprises receiving a plurality of preamble signals including the training sequences and a plurality of data signals, each preamble signal and data signal being associated with one of the plurality of signals that traveled along different paths from the first plurality of antennae to the second plurality of antennae.

9. The method of claim 1, wherein receiving the plurality of signals from the first plurality of antennae substantially concurrently at a second plurality of antennae comprises receiving the plurality of signals from a plurality of mobile units substantially concurrently at an access point, each mobile unit having a third plurality of antennae and each access point having the second plurality of antennae.

10. The method of claim 1, wherein receiving the plurality of signals from the first plurality of antennae substantially concurrently at a second plurality of antennae comprises receiving the plurality of signals from an access point substantially concurrently at a plurality of mobile units, each mobile unit having a third plurality of antennae and each access point having the first plurality of antennae.

11. An access point in a wireless local area network, comprising:
a first plurality of antennae capable of receiving, substantially concurrently at a substantially common frequency, a plurality of signals from at least one mobile unit, each of the at least one mobile unit being associated with a second plurality of antennae; and
a processor communicatively coupled to the first plurality of antennae and capable of determining at least one transmission channel corresponding to the at least one mobile unit using the plurality of signals.

12. The access point of claim 11, wherein the first plurality of antennae are capable of receiving a plurality of signals that traveled along different paths between the first plurality of antennae and the second plurality of antennae associated with each mobile unit.

13. The access point of claim 12, wherein the processor is capable of determining the at least one transmission channel using the plurality of signals that traveled along different paths between the first plurality of antennae and the second plurality of antennae associated with each mobile unit.

14. The access point of claim 13, wherein the processor is capable of determining the at least one transmission channel using a plurality of training sequences associated with each of the plurality of signals that traveled along different paths between the first plurality of antennae and the second plurality of antennae associated with each mobile unit.

15. The access point of claim 14, wherein the processor is capable of determining a transmission matrix using the plurality of training sequences associated with the plurality of signals that traveled along different paths between the first plurality of antennae and the second plurality of antennae associated with each mobile unit.

16. The access point of claim 15, wherein the processor is capable of decoding the symbols received from each mobile unit using the transmission matrix.

17. The access point of claim 11, further comprising a transmitter capable of transmitting a symbol to each mobile unit substantially concurrently at the common frequency using the transmission channel corresponding to the mobile unit.

18. The access point of claim 11, further comprising a receiver capable of receiving a symbol from each mobile unit substantially concurrently at the common frequency using the transmission channel corresponding to the mobile unit.

19. A mobile unit for use in a wireless local area network, comprising:
a first plurality of antennae capable of receiving, substantially concurrently at a substantially common frequency, a plurality of signals from a second plurality of antennae associated with an access point; and
a processor communicatively coupled to the first plurality of antennae and capable of determining a transmission channel corresponding to the mobile unit using the plurality of signals.

20. The mobile unit of claim 19, wherein the first plurality of antennae are capable of receiving, substantially concurrently at the common frequency, a plurality of signals that traveled along different paths between the first plurality of antennae and the second plurality of antennae.

21. The mobile unit of claim 20, wherein the processor is capable of determining the transmission channel using the plurality of signals that traveled along different paths between the first plurality of antennae and the second plurality of antennae.

22. The mobile unit of claim 21, wherein the processor is capable of determining the transmission channel using a plurality of training sequences associated with each of the plurality of signals that traveled along different paths between the first plurality of antennae and the second plurality of antennae.

23. The mobile unit of claim 22, wherein the processor is capable of determining a transmission matrix using the plurality of training sequences associated with the plurality of signals that traveled along different paths between the first plurality of antennae and the second plurality of antennae.

24. The mobile unit of claim 23, wherein the processor is capable of decoding the symbols received from each mobile unit using the transmission matrix.

25. The mobile unit of claim 19, further comprising a transmitter capable of transmitting a symbol at the common frequency to the access point using the transmission channel substantially concurrently with at least one other mobile unit using a different transmission channel.

26. The mobile unit of claim 19, further comprising a receiver capable of receiving a symbol at the common frequency from the access point using the transmission channel.

27. The mobile unit of claim 19, wherein the mobile unit is at least one of a cellular telephone, a personal data assistant, a scanner, and a portable computer.

28. A wireless local area network, comprising:
at least one access point having a first plurality of antennae capable of receiving and transmitting a plurality of signals substantially concurrently at a substantially common frequency; and
a plurality of mobile units, each mobile unit having a second plurality of antennae capable of receiving and transmitting a plurality of signals substantially concurrently at the substantially common frequency,
wherein the access point comprises:
a processor communicatively coupled to the first plurality of antennae and capable of determining a plurality of transmission channels using a plurality of signals transmitted by the second plurality of antennae associated with each of the mobile units and associating at least one of the plurality of transmission channels with a corresponding one of the mobile units,
and wherein the mobile units each comprise:
a processor communicatively coupled to the plurality of antennae and capable of determining at least one transmission channel corresponding to the mobile unit using a plurality of signals transmitted by the first plurality of antennae associated with the access point.

29. The wireless local area network of claim 28, wherein the access point processor is capable of determining the plurality of transmission channels corresponding to the mobile units using a plurality of training sequences associated with each of the plurality of signals transmitted by the second plurality of antennae associated with each of the mobile units, and wherein each of the plurality of signals transmitted by the second plurality of antennae associated with each of the mobile units traveled along different paths between the first plurality of antennae and the second plurality of antennae.

30. The wireless local area network of claim 28, wherein the mobile unit processors are capable of determining the transmission channel corresponding to the respective mobile unit using a plurality of training sequences associated with the plurality of signals transmitted by the first plurality of antennae associated with the access point, and wherein each of the plurality of signals transmitted by the first plurality of antennae associated with the access point traveled along different paths between the first plurality of antennae and the second plurality of antennae.

31. The wireless local area network of claim 28, wherein the access point processor is capable of associating more than one of the plurality of transmission channels with the corresponding one of the mobile units.

32. The wireless local area network of claim 31, wherein the more than one of the plurality of transmission channels are used in at least one of a spatial multiplexing mode, a fat-pipe mode, a progressive bit rate mode, a spatial diversity mode, and a space-time coding mode.

33. The wireless local area network of claim 28, wherein the mobile unit processor is capable of determining a plurality of transmission channels corresponding to the mobile unit.

34. The wireless local area network of claim 33, wherein the plurality of transmission channels corresponding to the mobile unit is used in at least one of a spatial multiplexing mode, a fat-pipe mode, a progressive bit rate mode, a spatial diversity mode, and a space-time coding mode.

35. The wireless local area network of claim 34, wherein the plurality of transmission channels corresponding to the mobile unit is used in a spatial diversity mode.

36. The wireless local area network of claim 28, wherein the first plurality of antennae comprises a first selected number of antennae and the second plurality of antennae comprises a second selected number of antennae.

37. The wireless local area network of claim 36, wherein the first selected number is equal to the second selected number.

38. The wireless local area network of claim 36, wherein the number of transmission channels is equal to at least one of the first selected number and the second selected number.

39. The wireless local area network of claim 28, further comprising a plurality of access points, each having a first plurality of antennae capable of receiving and transmitting a plurality of signals substantially concurrently at a substantially common frequency from at least one cell in a coverage area.

40. The wireless local area network of claim 28, wherein each mobile unit is at least one of a cellular telephone, a personal data assistant, a scanner, and a portable computer.
